(19) United States
(12) Patent Application Publication
(10) Pub. No.: US 2004/0151879 A1
(43) Pub. Date: Aug. 5, 2004

(54) Polypropylene resin molding composite for automobile

(76) Inventors: Masaaki Yokoyama, Yokkaichi-shi (JP); Masahiro Tanaka, Yokkaichi-shi (JP); Keiichi Honjo, Wako-shi (JP); Sukekuni Itoh, Wako-shi (JP); Yoshikazu Morinaga, Wako-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/758,100

(22) Filed: Jan. 16, 2004

Related U.S. Application Data
(62) Division of application No. 09/870,152, filed on May 30, 2001, now abandoned.

(30) Foreign Application Priority Data
Jun. 5, 2000 (JP) 2000-168183

(51) Int. Cl. B32B 3/12

(52) U.S. Cl. 428/158

(57) ABSTRACT

A foam layer can be formed at a temperature at which the surface quality of a surface layer is not deteriorated, and a molding technique that is excellent in adhesiveness of a foam layer and a surface layer or/and a base member is developed. For the purpose of obtaining a polypropylene resin molding composite for automobile, the present invention is characterized by a polypropylene resin molding composite for automobile comprising a surface layer and a foam layer, or a surface layer, a foam layer, and a base member, wherein the surface layer comprises a surface layer of a polypropylene resin and a laminate of a cushioning material, where the cushioning material is a polypropylene resin expanded sheet, and the foam layer comprises thermoplastic resin expanded particles comprising a core that is made of a polypropylene resin and is in an expanded state and a polyethylene resin coat layer covering the core and is in a substantially non-expanded state.

### BACKGROUND OF THE INVENTION

1. Field of the Invention

The present invention relates to a polypropylene resin molding composite for automobile and, more specifically, to a polypropylene resin molding composite for automobile using thermoplastic expanded resin particles.

2. Description of the Related Art

With respect to an interior decoration member for automobile, there has hitherto been a member comprising an intervening foam layer between a base member of a solid resin and a surface layer, thereby attaching soft touch to the member to make it luxurious. The process for producing such an interior decoration member for automobile is disclosed in a Japanese patent publication (Japanese Patent No. 2500645).

The process for producing an interior decoration member for automobile disclosed in the above patent publication comprises placing a sheet for a surface layer made of polypropylene on a mold, and on the other mold, placing a base member made of a solid resin that is made of polypropylene and contains fillers, filling expanded resin particles made of polypropylene into the space between the sheet for the surface layer and the base member, thereby fusion-bonding particles with one another to form a foam layer. Thus, this process provides such a mold.

However, the hitherto mold producing technique needs high temperature or high pressure steam heating when expanded resin particles are fusion-bonded. This leads to a drawback that surface quality of a surface layer is deteriorated by heat when heating. Therefore there is another drawback that when a design as an interior decoration member is formed on the surface of a surface layer, the design becomes difficult to predominate. There is also another problem that if molding is carried out at a low temperature, fusion-bonded between expanded resin particles is deteriorated and adhesion of the surface layer and the foam layer and of the foam layer and the base member are also deteriorated.

Furthermore, the above mentioned hitherto molding composite producing technique requires to heat for a long time by a high temperature steam in order to increase adhesiveness between a sheet for a surface layer and expanded resin particles. Because of this condition, when fusion-bonded by heating is conducted, much moisture in the gas state infiltrates into spaces between expanded resin particles or into particles themselves. If cooling is carried out under this condition, moisture condenses from the gas state to the liquid state, thereby causing great volume shrinkage.

On this account, pressure in the spaces between expanded resin particles or in the particles themselves reduces, thereby causing shrinkage or deformation of an expanded mold made of these particles. This leads to a problem that shape stability becomes worse, that it is hard to obtain a mold fitted exactly in a mold, and that surface appearance of a surface layer is bad. Moreover, in respect of an expanded mold, it is needed that expanded resin particles are sufficiently fusion-bonded with one another, thereby achieving a high mechanical strength.

The present inventors have investigated wholeheartedly these problems of a hitherto molding composite having a foam layer, thereby developing an excellent molding technique that a foam layer can be molded at such a temperature as not to deteriorate surface quality of a surface layer, and a technique excellent in adhesiveness of a foam layer and a surface layer or/and a base member, and achieving a polypropylene resin molding composite for automobile.

### SUMMARY OF THE INVENTION

The present invention is a polypropylene resin molding composite for automobile, and is constituted as follows to overcome the above mentioned technical problems. That is, the present invention is characterized by a polypropylene resin molding composite for automobile comprising a surface layer and a foam layer, or a surface layer, a foam layer, and a base member, wherein the surface layer comprises a surface layer of a polypropylene resin and a laminate of a cushioning material., where the cushioning material is a polypropylene resin expanded sheet having a compressive hardness of 0.1 MPa or higher, and the foam layer comprises thermoplastic resin expanded particles comprising a core that is made of a polypropylene resin and is in an expanded state and a polyethylene resin coat that covering the core and is in a substantially non-expanded state.

The polypropylene resin molding composite for automobile of the present invention is consisted of the above mentioned required elements, and may be satisfactorily accomplished in the case that the elements are specifically the following elements. One of the specific elements is that the average particle diameter of the thermoplastic resin expanded particles is from 1.5 to 4.0 mm.

### BRIEF DESCRIPTION OF THE DRAWINGS

FIG. 1 is a perspective view of the thermoplastic expanded resin particles of the foam layer constituting the polypropylene resin molding composite for automobile of the present invention.

FIG. 2 is a partial sectional view of an embodiment in which the polypropylene resin molding composite for automobile of the present invention is applied to a dashboard.

### DESCRIPTION OF THE PREFERRED EMBODIMENT

The foam layer constituting the polypropylene resin molding composite for automobile of the present invention uses expanded resin particles comprising a particular core and a coat covering the core. On that account, without using high temperature and high pressure steam that has hitherto been used as a heating medium when an expanded resin mold is produced, an expanded resin mold can be obtained by heating with comparatively low temperature and low pressure steam.

The core is constituted by a polypropylene resin. Preferable examples of such a polypropylene resin include a propylene homopolymer and random copolymers or block copolymers of propylene with α-olefin except propylene. On this account, a resin molding composite that is inexpensive, excellent in recyclability, light, and excellent in insulation and cushioning ability can be obtained.

The coat of the expanded resin particles is preferably in the substantially non-expanded state. “The substantially non-expanded state” means a film state that has no bubble structure. The film state may have pores, for example, may be reticulated. Furthermore, the coat is preferably a polyethylene resin that has a melting point lower than the polypropylene resin of the above mentioned core, or that substantially exhibits no melting point. The melting point of the coat is preferably 10° C. or more lower than the melting point of the polypropylene resin constituting the above mentioned core. Temperature difference between the melting point of the coat and that of the polypropylene resin is preferably 15 to 70° C.

“Substantially exhibit no melting point” means that when measurement of a melting point by a differential scanning calorimeter is carried out, no crystalline melting point is exhibited because of non-crystalline resin. However, such a resin can be used as a coat since the resins themselves are fusion-bonded at a considerably low temperature. In the case of such a polyethylene resin, the temporary melting point is set at 100° C. and melting point difference between this resin and the polypropylene resin constituting the core is calculated.

Examples of such a low melting point polyethylene resin include low density polyethylene, linear low density polyethylene, linear ultra-low density polyethylene as well as copolymers of ethylene with vinyl acetate, unsaturated carboxylic acid esters, unsaturated carboxylic acids, vinyl alcohol and the like.

Examples of a polyethylene resin that substantially exhibits no melting point include rubbers and elastomers such as ethylene/propylene rubber, ethylene/propylene/diene rubber, ethylene/acrylic rubber, chlorinated polyethylene rubber, and chlorosulfonated polyethylene rubber.

These polyethylene resins may be used singly or as a composition of two or more kinds of the resins.

Of the polyethylene resins constituting the above coat, low density polyethylene, linear low density polyethylene, and linear ultra-low density polyethylene are preferable. Of these, linear low density polyethylene and linear ultra-low density polyethylene that are polymerized using metallocene catalyst are most preferable.

The above polyethylene resins constituting the coat of expanded resin particles has preferably substantially no melting point or, if any, a melting point of 125° C. or lower. The reason is because the heating temperature when expanded resin particles are molded is set at a lower temperature. Furthermore, concerning the coat, an ethylene polymer having a melting point of 10° C. or more lower than that of the polypropylene resin constituting the core may be preferably selected and used.

If the above melting point difference is smaller than 10° C., under the condition that the polypropylene resin of the core is expanded, the coat made of the polyethylene resin is also likely to be expanded.

The above coat is preferably a mixture of the above polyethylene resin and a polypropylene resin that is the same kind as the core. This leads to improvement of adhesiveness between the coat and the core.

The blending content of the polypropylene resin in the coat made of a polyethylene resin is selected from the range from 1 to 100 parts by weight, preferably from 1 to 50 parts by weight for 100 parts by weight of the polyethylene resin. If the blending content of the polypropylene resin is smaller than 1 part by weight, effect of improvement of adhesiveness between the core and the coat is low. If the blending content exceeds 100 parts by weight, since the sea and island conformation of the coat in which the polyethylene resin makes a continuous layer changes, the polypropylene resin constitutes a continuous sea phase. On this account, the heating temperature when molding cannot be lowered.

In expanded resin particles, the thickness of the coat made of a polyethylene resin is from 1 to 150 μm, preferably from 10 to 100 μm. If the thickness of the coat is smaller than 1 μm, effect of reduction of the heating temperature when molding is weak. On the other hand, if the thickness of the coat exceeds 150 μm, although the heating temperature can be lowered when molding, the proportion of the coat of the polyethylene resin that is comparatively weak in strength becomes greater, and mechanical strength of a mold becomes lowered.

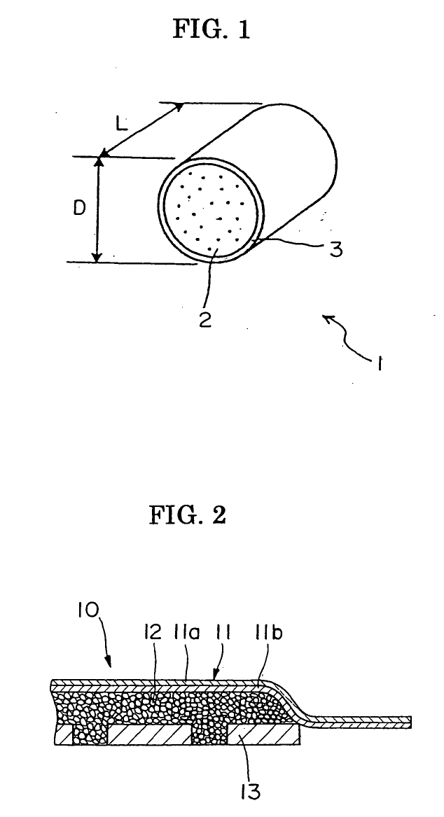

An expanded resin particle 1 constituting the foam layer of the polypropylene resin molding composite for automobile of the present invention is shown in FIG. 1. As shown in FIG. 1, L/D ratio, which is a ratio of a long diameter L and a short diameter D of expanded resin particle 1, is about from 0.5 to 3. If the ratio is smaller than 0.5, surface area of the coat 3 is diminished, thereby leading to a poor fusion-bonded. If L/D ratio exceeds 3, since particle shape is long and narrow, filling efficiency is deteriorated, thereby leading to a poor molding and lowering of shape stability.

In the case of comparatively greater L/D ratio of 1.5 to 3, it becomes easy to obtain a mold having many spaces. Concerning molding performance, L/D ratio is preferably from 0.7 to 2. The average of the short diameter D of expanded resin particles 1, that is, average particle diameter is 1 to 6 mm, and preferably 1.5 to 4.0 mm. By making the particles so as to have such a particle diameter, the particles can penetrate well deep into a comparatively narrow space or a space with a complicated shape.

Expanded resin particles 1 can be obtained by, for example, after impregnating with a volatile expanding agent composite particles, as shown in FIG. 1, which comprises a core 2 made of a crystalline polypropylene resin and a coat 3 containing as a main ingredient a polyethylene resin that has a lower melting point than the polypropylene resin or that exhibits substantially no melting point, heating to be expanded.

Examples of the above volatile expanding agent include lower aliphatic hydrocarbons such as propane, butane, pentane, heptane, cyclopentane and cyclohexane, halogenated hydrocarbons such as dichlorodifluoromethane and trichloromonofluoromethane, and inorganic gases such as nitrogen, air and carbon dioxide. These are used singly or combined with two or more kinds of the agents.

Expanded resin particles are molded by steam. Molding is carried out at a heating temperature of expanded resin particles lower than a melting point of a polypropylene resin of a core. A temperature 5° C. or more lower than the melting point of the above resin is preferable. A temperature 10° C. or more lower than the melting point of the polypropylene resin constituting the core is more preferable. Because of the necessity of fusion-bonded of the particles, molding is conducted at a heating temperature higher than a melting point of a coat of expanded resin particles.

When molding expanded resin particles, the compression state of expanded resin particles is appropriately set according to the physical properties required for a mold. If compression is reduced, a mold having spaces, in which a contact area of expanded resin particles themselves become smaller, can be obtained. In the present invention, void fraction of a foam layer is preferably from 1% to 50%. Either heating or compression may be carried out earlier. Compression may be carried out during heating.

Molding of expanded resin particles is preferably carried out in the condition that bulk volume of the expanded resin particles is compressed 50 to 99% by using a mold to make an apparent density higher. If the compression rate is smaller than 50% (larger compression), since a resin molding composite having almost no spaces is obtained, the density of a resin molding composite becomes too large. If the compression rate is larger than 99% (smaller compression), since a contact area of expanded resin particles themselves becomes smaller, a resin molding composite of which fusion-bonded strength is weak is obtained.

Expanded resin particles comprises a core that is a closed wall cell foam made of a polypropylene resin, and a coat that contains a polyethylene resin and is substantially a film shape. On that account, bypassing steam that has a comparatively low heat capacity through the spaces between expanded resin particles filled in a mold, expanded resin particles can be heated to a temperature required for fusion-bonded of the coat by melting the coat without melting the core that has a higher melting point than the coat. A resin molding composite in which expanded resin particles themselves, and a foam layer and a cushioning material are fusion-bonded can be obtained by pressing and fusion-bonding the coats with each other using a compression repulsion that the core has.

The above mentioned expanded resin particles has a composite structure that is constituted by a core that is in an expanded state and is made of a polypropylene resin, and a polyethylene resin coat covering the core that is in a substantially non-expanded state. The core in an expanded state, for example, has a closed cell structure or an open cell structure, and a closed cell structure is preferable. The reason is because a closed cell structure has a high compression repulsion of the core when molding since a closed cell structure is made of many closed cells, and compressive strength is high even at a low density. Closed cell rate of the core is preferably 50% or higher, and more preferably 70% or higher. This makes a compression repulsion of the core when molding further higher, and a resin molding composite of which compressive strength is high even at a low density can be obtained.

Since the expanded resin particles for use in the present invention can be fusion-bonded at a low temperature, when the particles are filled in a mold and fusion-bonded using a comparatively low temperature and low pressure steam, infiltration of steam into the spaces between expanded resin particles or into the particles themselves when molding is reduced, compared with the case using a high temperature and high-pressure steam. Therefore volume shrinkage of a mold accompanying with volume shrinkage by condensation of steam is reduced. On this account, this resin molding composite is excellent in shape stability. High temperature aging process in order to recover dimension and shrinkage deformation is not necessary or is sufficient for a short period of time.

Furthermore, in the case of molding by a comparatively low temperature and low pressure steam, a heavy mold that has a structure capable of resisting a high pressure steam used for molding of hitherto expanded resin particles is not necessary, and consumption of thermal energy is small. If a surface layer made of a polypropylene resin with cushioning material and expanded resin particles are molded together in a mold, poor fusion-bonded affected by moisture of steam is decreased, thereby fusion-bonding strongly the surface layer of a polypropylene resin with cushioning material and the coat of expanded resin particles. Accordingly, the resin molding composite of the present invention has a high strength of fusion-bonded, and is excellent in mechanical strength.

A surface layer and a base member, which are fusion-bonded and integrated in a laminated shape with a foam layer made of these expanded resin particles, are placed in advance in a mold for molding expanded resin particles and laminated. The surface layer is a laminate comprising a surface layer and a cushioning material. The surface layer is formed by a polypropylene resin sheet. The cushioning material is formed by a polypropylene resin expanded sheet having a compressive hardness of 0.1 MPa or higher.

Polypropylene resins mean resins having a propylene content of 50% by weight or greater, such as propylene homopolymer, ethylene-propylene random copolymer, ethylene-propylene block copolymer, ethylene-propylene-butene random terpolymer, propylene-vinyl chloride copolymer, propylene-butene copolymer, and propylene-maleic anhydride copolymer. These resins are used singly or combined with two or more kinds of the resins.

In this case, as a polypropylene resin, which is a main ingredient, a resin having a melting point of 130° C. or higher is desired in order to give a resin sheet and an expanded sheet heat resistance. From the standpoint of enhancing soft touch feeling, as a main ingredient polypropylene resin, it is preferable to use a single resin or a mixture of two or more kinds of resins selected from ethylene-propylene random copolymer, propylene-butene random copolymer, and ethylene-propylene-butene random terpolymer.

For the purpose of giving further soft touch feeling a resin sheet and an expanded sheet, other polymers or copolymers may be blended as a secondary ingredient with a main ingredient polypropylene resin. As such a secondary ingredient, a polyolefin polymer or copolymer is preferable, and particularly preferably one or more than one polyolefin polymers or copolymers selected from polyethylene resins such as linear ultra-low density polyethylene, branched low density polyethylene resin, linear low density polyethylene resin, middle density polyethylene resin, and high density polyethylene resin; polyolefin elastomers such as ethylene-propylene rubber, ethylene-butene rubber, ethylene-octene rubber, and propylene-butene rubber; and polybutene resin. For the purpose of enhancing soft touch feeling of a resin sheet and an expanded sheet, if such a polyolefin polymer or copolymer has a melting point, the melting point is lower than 140° C., preferably 135° C. or lower, and desirably 130° C. or lower.

This polypropylene resin is preferably non-crosslinked, and may be crosslinked with peroxides or radioactive rays.

A typical process for producing a polypropylene resin expanded sheet is as follows. After melt-kneading a propylene resin with a pyrolytic expanding agent and, if necessary, various additives in an extruder at a temperature at which the expanding agent is not substantially pyrolyzed, extrusion is carried out to produce an expandable sheet. Then an expanded sheet is obtained by heating the sheet over a temperature at which the expanding agent of the obtained expandable sheet is pyrolyzed.

As a polypropylene resin, a mixture of a polypropylene resin with other thermoplastic resins that is miscible with a polypropylene resin may be used. Specific examples of such a thermoplastic resin include, for example, low density polyethylene, polystyrene, polybutene, and ionomers. The mixing content of such a thermoplastic resin is usually 20 parts by weight, preferably 5 to 10 parts by weight for 100 parts by weight of a propylene resin.

The thickness of a polypropylene resin expanded sheet is preferably about 1 to 4 mm, particularly preferably about 1.5 to 3.5 mm because if the thickness is too small, touch of the resulted interior decoration member for automobile is likely to be felt hard and buffering performance is likely to become small, and if it is too large, touch of the resulted interior decoration member for automobile is likely to become too soft.

The expansion magnification of such an expanded sheet is preferably about 10 to 30 times, particularly preferably 25 times or smaller, because if the magnification is too large, touch of the resulted interior decoration member for automobile is likely to become too soft. Moreover, in view of the quality of surface appearance of a molding composite, the expanded sheet having a compressive hardness (JIS K6767) of 0.1 MPa or higher is used.

Integration of a polypropylene resin sheet as a surface layer and a polypropylene resin expanded sheet as a cushioning material is carried out by, for example, a method of hot melt integration and a method of integrating with an adhesive. However, the present invention is not limited to these integration methods.

In the present invention, a surface layer that a polypropylene resin sheet and a polypropylene resin expanded sheet are integrated in advance may be prepared, and this may be integrated with a foam layer in a mold.

As a surface layer and a cushioning material constituting a laminate that is a surface layer, a film shape mold, a sheet shape mold and a mold that is previously molded to some extent by vacuum molding or compression molding are used, and the thickness thereof is from 1 to 5 mm.

An example of production of the composite of the present invention is a cast molding. Specifically, a method that is generally used is as follows. A surface layer is placed in a mold that can be heated by steam, and if necessary, on the other side, a base member made of a comparatively hard synthetic resin plate or the like is placed. On the back side of the surface layer (between the surface layer and the base member), expanded resin particles are filled and heated by steam, thereby fusion-bonding the expanded resin particles with each other, and expanded resin particles and the surface layer (and the base member) to be integrated.

In the present invention, a structure that is formed by fusion-bonding a foam layer formed by expanded resin particles and a cushioning material of a surface layer (other layers may be placed between these layers) is adopted. By the existence of the cushioning material, stress absorbing effect between the surface layer and the foam layer, and heat insulating effect for the surface layer when molding are desired, therefore accordingly a grain pattern of the surface layer (surface pattern) is not erased. Furthermore, there is an effect that the surface layer and the foam layer do not come off with a lapse of time.

In order to exert these effects and to keep a shape of the cushioning material itself when molding, a cushioning material having a compressive hardness of 0.1 MPa or higher is selected.

As a base member made on the other side of a surface layer, a comparatively hard polyolefin resins are generally used. This base member is generally used for shape keeping or as a fixation keeping portion against other things such as a automobile body and the like. Since this base member is not exposed outside, it is not necessary to care about surface patterns and the like of the base member.

Concerning materials of the base member, considering its adhesiveness with a foam, polyolefin resins are preferably used.

If a foam, a surface layer and a base member are all constituted by polyolefin resins, it is preferable because regeneration can be easily conducted when retrieved things are crushed and recycled.

A general molding method is as follows. After expanded resin particles are filled in a mold in which a surface layer and a base member is respectively placed, heating is carried out by passing steam through the spaces between the expanded resin particles filled in the mold, thereby fusion-bonding the expanded resin particles. Subsequently cooling is conducted to form a molding composite.

FIG. 2 is a partially sectional view showing a portion of the mold in section in the case that the polyolefin resin molding composite for automobile of the present invention is applied to molding of an automobile dashboard. This dashboard 10 comprises a surface layer 11, a foam layer 12, and a base member 13 as shown in FIG. 2.

Concerning the surface layer 11, the surface layer 11a is formed by a sheet made of a polypropylene resin, the cushioning material 11b is formed by an expanded sheet made of a polypropylene resin, and a mat pattern such as a grain pattern is formed on the surface of the surface layer 11a. The base member 13 comprises a comparatively hard resin containing fillers and made of polypropylene. The foam layer 12 that is filled between the base member 13 and the surface layer 11 is formed using the above mentioned thermoplastic expanded resin particles.

### EXAMPLES

The polypropylene resin molding composite for automobile in the present invention is illustrated in further detail by examples, the present invention is not limited to the following examples as long as it is beyond the object.

### Example 1

As shown in Table 1, using a single screw extruder having an inner diameter of 40 mm, an ethylene/propylene random copolymer (melting point 153° C.) of which the ethylene content is 1.5% by weight was kneaded, and using a single screw extruder having an inner diameter of 26 mm, a linear low density polyethylene (melting point 100° C.) that is polymerized with a metallocene catalyst having a density of 0.907 was kneaded. Subsequently, ethylene/propylene random copolymer was used for a core and linear low density polyethylene was used for a coat, and a strand was extruded from a die having a die orifice of a diameter of 1.5 mm.

After cooling this strand by passing through a water tank, the strand was cut so as to have 1.2 mg of the average weight. The cross section of this composite particle was observed with a phase contrast microscope, and it was found that linear low density polyethylene of thickness of 30 μm covered ethylene/propylene random copolymer.

Next, in a closed vessel, 100 parts by weight of the above mentioned composite particles, 250 parts by weight of water, 1.0 part by weight of calcium tertiary phosphate having particle diameters of 0.3 to 0.5 μm, and 0.007 parts by weight of sodium dodecylbenzenesulfonate were placed. Subsequently, 13 parts by weight of butane was supplied into the closed vessel with stirring. After the contents were filled at a filling rate of 62%, temperature was elevated for an hour until a temperature of 145° C. was reached and the temperature was maintained for 30 minutes.

Subsequently, the releasing valve in the bottom of the closed vessel was opened, and at the same time nitrogen gas was introduced from outside into a gas phase inside the closed vessel, thereby maintaining the pressure in the vessel and releasing the contents under atmospheric pressure to obtain expanded resin particles. Thus obtained expanded resin particles had an average bulk density of 45 Kg/m³ and an average cell diameter of 230 μm, and there was no blocking of the expanded resin particles themselves.

The cross section of this expanded resin particle was observed with a phase contrast microscope, and it was found that ethylene/propylene random copolymer of the core was in a closed cell expanded state, and on the other hand, linear low density polyethylene was in a substantially non-expanded film state and covered the expanded state core of ethylene/propylene random copolymer. L/D, a ratio of a long diameter L and a short diameter D of an expanded resin particle was 0.9, the average particle diameter thereof was 2.5 mm.

These expanded resin particles was fully dried in a drying room at 40° C. After these expanded resin particles were compressed and filled in a breathable mold in which a surface layer comprising a cushioning material (material: a polypropylene resin expanded sheet, thickness: 2.0 mm, melting point: 143° C.) laminated onto a surface jacket (material: a polypropylene resin sheet, thickness: 1.4 mm), and a base member (material: a polypropylene resin, thickness: 3.5 mm, melting point: 166° C.) were respectively placed, surface temperature of expanded resin particles, which was filled in the mold, was heated to 130° C. by steam to fusion-bond expand resin particles. After that, the product was cooled, and a molding composite was taken out from inside the mold. The bulk density of the foam layer was 53 Kg/m³, the size of the molding composite was 200 mm in length, 300 mm in width, and 40 mm in thickness. The shape was just the same as the mold without shrinkage and deformation in the surface layer.

### Comparative Example 1

A molding composite was obtained in the same manner as in the above Example 1. In this case, as shown in Table 1, a polypropylene resin expanded sheet having expansion magnification of 25 times, compressive hardness of 0.06 MPa, and melting point of 138° C. was used as a cushioning material. Concerning the molding composite taken out from inside the mold, although the form layer was adhered and integrated with the surface layer, there was shrinkage, deformation or the like in the surface layer.

### Example 2

A molding composite was obtained in the same manner as in the above Example 1. In this case, ethylene-propylene random copolymer having a melting point of 141° C. and linear low density polyethylene having a melting point of 123° C. were used, and expanded resin particles of an average bulk density of 42 Kg/m³ was obtained. L/D, a ratio of a long diameter L and a short diameter D of an expanded resin particle was 1.5, the average particle diameter thereof was 2.2 mm.

As in Example 1, after these expanded resin particles were compressed and filled in a breathable mold in which a surface layer (as shown in Table 1, a polypropylene resin expanded sheet constituting cushioning material had thickness of 2.5 mm, expansion magnification of 15 times, and compressive hardness of 0.17 MPa) and a base member were respectively placed, surface temperature of expanded resin particles was heated to 128° C. to fusion-bond expanded resin particles. A molding composite taken out from inside the mold has good appearance. The shape was just the same as the mold without shrinkage and deformation in the surface layer.

### Comparative Example 2

A molding composite was obtained in the same manner as in Example 2. In this case, as shown in Table 1, a polypropylene resin expanded sheet having expansion magnification of 20 times, compressive hardness of 0.08 MPa, and melting point of 138° C. was used as a cushioning material. Concerning the molding composite taken out from inside the mold, although the form layer was adhered and integrated with the surface layer, there was shrinkage, deformation or the like in the surface layer.

### Example 3

A molding composite was obtained in the same manner as in the above Example 1. In this case, the average bulk density of expanded resin particles was 50 Kg/m³. L/D, a ratio of a long diameter L and a short diameter D of an expanded resin particle was 1.2, the average particle diameter thereof was 2.4 mm. As in Example 1, after these expanded resin particles were compressed and filled in a breathable mold in which a surface layer (as shown in Table 1, a polypropylene resin expanded sheet constituting cushioning material had thickness of 1.5 mm, expansion magnification of 11 times, compressive hardness of 0.13 MPa and melting point of 146° C.) and a base member were respectively placed, surface temperature of expanded resin particles was heated to 125° C. to fusion-bond expanded resin particles. A molding composite taken out from inside the mold has good appearance. The shape was just the same as the mold without shrinkage and deformation in the surface layer.

TABLE 1

| | | Comparative | | Comparative | |
|---|---|---|---|---|---|
| | Example 1 | Example 1 | Example 2 | Example 2 | Example 3 |
| The resin of the core | ET-PR 153 | ET-PR 153 | ET-PR 141 | ET-PR 141 | ET-PR 153 |
| Melting point (° C.) | | | | | |
| The resin of the coat | M-LLDPE 100 | M-LLDPE 100 | LLDPE 123 | LLDPE 123 | M-LLDPE 100 |
| Melting point (° C.) | | | | | |
| Average bulk density (Kg/m³) | 45 | 45 | 42 | 42 | 50 |
| L/D ratio | 0.9 | 0.9 | 1.5 | 1.5 | 1.2 |
| Average particle diameter (mm) | 2.5 | 2.5 | 2.2 | 2.2 | 2.4 |
| The state of the core | Expanded | Expanded | Expanded | Expanded | Expanded |
| The state of the coat | Substantially | Substantially | Substantially | Substantially | Substantially |
| | non-expanded | non-expanded | non-expanded | non-expanded | non-expanded |
| Polypropylene resin expanded sheet | | | | | |
| Melting point (° C.) | 143 | 138 | 143 | 138 | 146 |
| Thickness (mm) | 2.0 | 2.0 | 2.5 | 2.5 | 1.5 |
| Expansion magnification (times) | 20 | 25 | 15 | 20 | 11 |
| Compressive hardness (MPa) | 0.11 | 0.06 | 0.17 | 0.08 | 0.13 |
| Heat molding temperature (° C.) | 130 | 130 | 128 | 128 | 125 |
| Compression ratio (%) | 15 | 15 | 25 | 25 | 30 |
| Fusion-bonded condition | ∘ | x | ∘ | x | ∘ |

ET-PR: ethylene-propylene random copolymer
M-LLDPE: linear low density polyethylene polymerized with a metallocene catalyst
LLDPE: linear low density polyethylene
∘: The foam layer is adhered and integrated with the surface layer, and there is no appearance abnormality such as shrinkage and deformation in the surface layer.
x: The form layer is adhered and integrated with the surface layer, but there is shrinkage and deformation in the surface layer

The physical properties in the above Examples 1 to 3 and Comparative Examples 1 and 2 were measured by the following methods.

<Melting Point>

Melting point was measured by a differential scanning calorimeter (DSC). First, 3 to 5 mg of a resin was heated until a temperature at which the crystal is melted was reached, then the resin was cooled down to room temperature at a rate of 10° C. per minute. Next, the resin was heated at a rate of 10° C. per minute, and thereby determining a melting temperature as a peak temperature of the endothermic curve thus obtained.

<Bulk Density of the Foam Layer>

A foam layer was cut out of the end mold, and the weight per unit volume (Kg/m³) was measured.

<Compression Ratio of the Foam Layer>

(bulk density of the foam layer−bulk density of expanded resin particles)/(bulk density of the foam layer)×100 (%)

<Fusion Bonding of the Surface Layer>

The molding composite taken out of inside the mold was allowed to stand at a temperature of 20° C., the appearance after 30 minutes was visually evaluated.

Although the applied Example of the present invention is explained by an example of a automobile dashboard, the present invention is not limited to such a use, and can be naturally applied to interior decoration members for automobile requiring cushioning performance, heat insulating performance, or sound insulating performance, such as a heat insulating panel.

As explained above, according to the polypropylene resin molding composite for automobile of the present invention, a foam layer can be formed at a temperature at which the surface quality of a surface layer is not deteriorated, and a resin molding composite that is excellent in adhesiveness of a foam layer and a surface layer or/and a base member can be obtained.

Moreover, according to the polypropylene resin molding composite for automobile of the present invention, since the melting point of a coat in thermoplastic resin expanded particles is set to a low temperature, appearance of the surface layer is not damaged. Furthermore, the thickness of a molding composite can be further thinned since average particle diameter of expanded resin particles is small. Thus, excellent effects are achieved according to the present invention.

What is claimed is:

1. A polypropylene resin molding composite for automobile comprising a surface layer and a foam layer, or a surface layer, a foam layer, and a base member,
the surface layer comprising a surface layer of a polypropylene resin and a laminate of a cushioning material, and the cushioning material being a polypropylene resin expanded sheet having a compressive hardness of 0.1 MPa or higher, and
the foam layer being thermoplastic resin expanded particles comprising a core that is made of a polypropylene resin and is in an expanded state and a polyethylene resin coat covering the core and in a substantially non-expanded state.

2. A polypropylene resin molding composite for automobile according to claim 1, wherein average particle diameter of the thermoplastic resin expanded particles is 1.5 to 4.0 mm.

3. A polypropylene resin molding composite for automobile according to claim 1 or 2, wherein the polyethylene resin coat has a melting point lower than the polypropylene resin of the core, or is a polyethylene resin that substantially exhibits no melting point.

4. A polypropylene resin molding composite for automobile according to claim 3, wherein the melting point of the coat is 10° C. or more lower than the melting point of the polypropylene resin constituting the core.
